(19) United States
(12) Patent Application Publication
(10) Pub. No.: US 2008/0319572 A1
(43) Pub. Date: Dec. 25, 2008

(54) Method and apparatus for operating terminal

(75) Inventor: Min Heui Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 12/149,031

(22) Filed: Apr. 25, 2008

(30) Foreign Application Priority Data
Jun. 19, 2007 (KR) 10-2007-0060145

(51) Int. Cl. G06F 7/00; A47G 29/00

(52) U.S. Cl. 700/213; 248/346.06

(57) ABSTRACT

An apparatus and method for operating a terminal, are discussed. According to an embodiment, the method includes receiving angle adjustment information of a terminal; and automatically controlling a position of the terminal according to the angle adjustment information.

This application claims the priority benefit of the Korean Patent Application No. 10-2007-0060145, filed on Jun. 19, 2007, which is hereby incorporated by reference as if fully set forth herein.

### BACKGROUND

1. Field of Invention

The present disclosure relates to an apparatus and method related to angle adjustment of a terminal and the operation of a system including the terminal.

2. Discussion of Background Art

As a terminal which is a kind of a user terminal and to which a navigation function and/or a function for a user is added is widely distributed, various systems including a navigation unit or portable multimedia players (PMPs) fixed on most of vehicles or the front window of the vehicles are easily found.

Generally, a navigation unit is mounted and used through a cradle that can mount the navigation unit thereon.

Also, most of navigation units are configured such that the cradle and a terminal are separated from each other. To adjust the terminal in a direction desired by a user, one or more fastening screws provided to the cradle are unscrewed to adjust an angle of the terminal, and then the fastening screws are fastened.

The cradle is an example of an angle adjustment unit or an angle adjustment means. Also, the cradle can mean a unit supporting something.

A terminal is fixed using a cradle that uses a flexible bar and whose direction can be changed only when artificial force is applied to the bar.

Generally the cradle is fixed on the front window of a vehicle or in a space provided below the window or on the vehicle itself. At this point, an adsorption rubber, which is a kind of an adsorption means, is added to the cradle to fix the cradle on the window or the vehicle.

### SUMMARY

Embodiments of the invention provide adjusting the angle of a terminal using angle adjustment information.

Embodiments of the invention also provide controlling the operating state and the operation of at least one of a terminal or an adjustment unit according to the degree of adsorption force of an adsorption portion, which is an example of a fixing portion of the terminal.

Embodiments of the invention also provide forming an angle adjustment unit and/or an adsorption portion on a terminal.

Embodiments of the invention also provide installing a terminal and/or a cradle on various positions without limitation in a place.

Embodiments of the invention also provide inputting angle adjustment information through various input units and/or routes. For example, a user inputs the information using a remote controller, or a user directly inputs the information into a terminal.

Further, the invention provides an apparatus and method for controlling a terminal, which address the limitations and disadvantages associated with the related art.

In one embodiment, a method for operating a terminal includes: inputting angle adjustment information of a terminal; and operating a driver using the angle adjustment information. For one example, at least one of a direction key input, the number of times of direction key inputs, and pressing time information is considered and derived as the angle adjustment information.

In another embodiment, a method for operating a terminal includes: receiving or inputting angle adjustment information of a terminal; transmitting the angle adjustment information; and operating a driver of an adjustment unit in response to the transmitted angle adjustment information.

In further another embodiment, a method for operating a terminal includes: measuring adsorption force of a fixing portion fixing at least one of a terminal and an adjustment unit; comparing the adsorption force with a predetermined reference value; and controlling an operating mode of at least one of the terminal and the adjustment unit depending on the comparison result.

In still further another embodiment, an apparatus for operating a terminal whose angle is adjustable includes: an input unit performing at least one of receiving and inputting angle adjustment information; an adjustment unit adjusting an angle using the angle adjustment information; a receiver receiving data to be output through an output unit; a processor processing data received through the receiver; and a controller controlling respective parts of the terminal.

The details of one or more embodiments of the invention are set forth in the accompanying drawings and the description below. Other features will be apparent from the description and drawings, and from the claims.

### BRIEF DESCRIPTION OF THE DRAWINGS

FIG. 1 is a system block diagram including respective units for angle adjustment of a terminal according to an embodiment of the present invention.

FIG. 2 is a view illustrating an example of an information format 200 in which terminal angle adjustment information is output through a remote controller according to an embodiment of the invention.

FIG. 3 is a block diagram illustrating an example of the construction of a terminal according to an embodiment of the present invention.

FIG. 4 is a block diagram illustrating an example of the construction of an adjustment unit according to an embodiment of the present invention.

FIG. 5 is a detailed view illustrating an example of the construction of an adjustment unit according to an embodiment of the present invention.

FIG. 6 is a view illustrating an example of the construction of a power supply terminal of a power source unit of a terminal according to an embodiment of the present invention.

FIG. 7 is a flowchart illustrating an operating process between respective units of the system of FIG. 1 adjusting the angle of the terminal according to an embodiment of the present invention.

FIG. 8 is a view illustrating an example of the operating mode of a terminal 800 according to adsorption information in an embodiment of Table 1 of the present invention.

FIG. 9 is a flowchart illustrating an alarm inform mode/data memory mode according to adsorption information in an embodiment of FIG. 8 of the present invention.

FIG. 10 is a view illustrating an example of directly inputting angle adjustment information to a terminal according to an embodiment of the present invention.

### DETAILED DESCRIPTION OF THE EMBODIMENTS

Method and apparatus for operating a terminal will now be described according to an embodiment of the present invention with reference to the accompanying drawings.

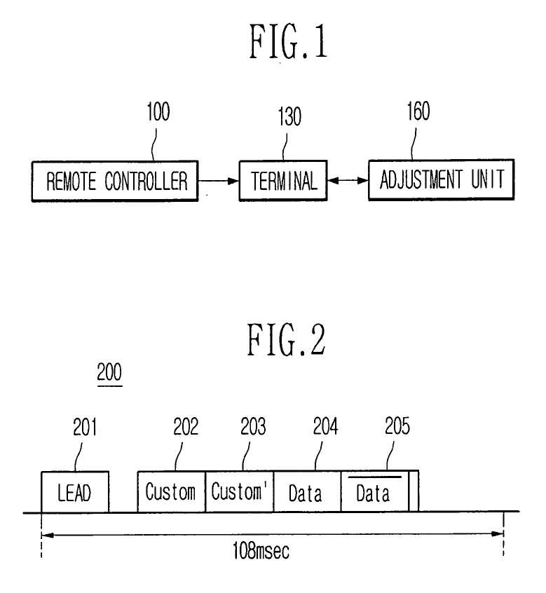

FIG. 1 is a system block diagram including respective units for angle adjustment of a terminal according to an embodiment of the present invention.

Referring to FIG. 1, the system includes a remote controller 100 for transmitting user input information for angle adjustment of a terminal 130, the terminal 130 for analyzing and outputting the user input information received through the remote controller 100, and an adjustment unit 160, which is an example of adjustment means, for performing an angle adjustment operation of the terminal 130 using information output from the terminal 130. All components of the system are operatively coupled and/or configured.

In another embodiment, a user can directly input angle adjustment information to the terminal 130 and/or the adjustment unit 160, or the user can transmit the angle adjustment information to the terminal 130 and/or the adjustment unit 160 through the remote controller 100.

The transmission of the angle adjustment information to the terminal 130 or the adjustment unit 160 using the remote controller 100, or the transmission of the angle adjustment information to the adjustment unit 160 directly through the terminal 130 can be performed by allowing a user to output the angle adjustment information using a predetermined key on the remote controller 100 or the terminal 130.

For example, at this point, when input of the predetermined key by the user is detected, the remote controller 100 transmits angle adjustment information input by the user to respective element unit(s) (e.g., terminal, adjustment unit, or terminal→adjustment unit) according to corresponding embodiments using an infrared signal, for example, in one embodiment.

The remote controller 100 can be formed in a bar type general shape or a wheel shape that is mounted on a steering wheel of a vehicle, or can be of any other shape and configuration.

The terminal 130 can include respective elements to perform infrared reception, have a navigation function, supply power to the adjustment unit 160, and read collected information using radio frequency identification (RFID).

Also, the terminal includes other units that can be attached on the vehicle, for example, other units that can be mounted in the system (including the vehicle) such as a navigation unit and a portable multimedia player (PMP).

The adjustment unit 160 preferably can be a unit that can fix the terminal 130 to the vehicle, and is called herein a “cradle”. For example, the adjustment unit 160 can be a cradle which removably fixes the terminal 130 therein, where the terminal 130 can be a mobile terminal such as a smart phone device, a PMP, a navigation device (e.g., GPS), a cell phone device, etc. The adjustment unit 160 itself can be mounted or fixed to a surface of a vehicle or other desirable device.

One or more motors are provided to the adjustment unit 160 according to the present invention. The motor receives power from the terminal 130 or separately has a power supply terminal to receive power from the vehicle.

Also, a chip (e.g., computer chip/software), which is a control unit that can control the motor according to angle adjustment information transmitted from the terminal 130, is provided in the adjustment unit 160.

Meanwhile, though the terminal 130 and the adjustment unit 160 are separately provided according to the embodiment of FIG. 1, the system can be designed and operated as one unit including only elements for angle adjustment. For example, as the construction of the adjustment unit, a motor driven for adjusting an angle and/or a unit for fixing the terminal can be integrally formed with the terminal according to other embodiments. As an example, the adjustment unit 160 can be included as part of the terminal 130.

Also, portions of the construction for angle adjustment can be modified to realize respective units according to embodiments of the invention.

Meanwhile, for the terms used in the present disclosure, general terms widely currently used have been selected as possible as they can. In a specific case, terms arbitrarily selected by an applicant may be used. In this case, since the meaning thereof is described in detail in the detailed description of the specification, the present disclosure should be understood in an aspect of meaning of such terms, not the simple names of such terms.

FIG. 2 is a view illustrating an example of an information format 200 in which terminal angle adjustment information is output through a remote controller (e.g., remote controller 100) according to an embodiment.

As illustrated in FIG. 2, the data allocation of the transmitted information format 200 includes a LEAD 201, a custom code (e.g., 8 bits) 202, a custom’ code or inverted custom code (e.g., 8 bits) 203, a data code (e.g., 8 bits) 204, and an inverted data code (e.g., 8 bits) 205.

The LEAD 201 is an initial input signal and represents a signal/information to be transmitted. The custom code 202 and the inverted custom code 203 include information regarding up, down, left, and right information representing terminal angle adjustment directions, which can be represented in the forms of, e.g., 00H, 01H, 02H, and 03H.

Also, the data code (8 bits) 204 and the inverted data code (8 bits) 205 represent the size values of 00H, 01H, 02H, and 03H. An adjustment angle of the terminal changes according to these size values.

The terminal 130 transmits angle adjustment information (e.g., in the form 200) to the adjustment unit 160. As discussed above, the terminal 130 may receive the angle adjustment information from the remote controller or directly from a user or from some other source. The adjustment unit 160 that has received a corresponding signal controls one or more motors according to the angle adjustment information to operate the motor(s) for controlling the adjustment unit 160 accordingly.

Though the user's command, which is the angle adjustment information, is realized through the remote controller 100 in the above description, the angle adjustment information can be directly input to the terminal 130 as illustrated in FIG. 10 in other embodiments.

Also, the angle adjustment information can be directly input to a transceiver 162 (FIG. 4) of the adjustment unit 160 through the remote controller 100 or another remote device.

Transmission/reception (communication) between the terminal 130 and the adjustment unit 160 is performed through a wired line and/or wirelessly.

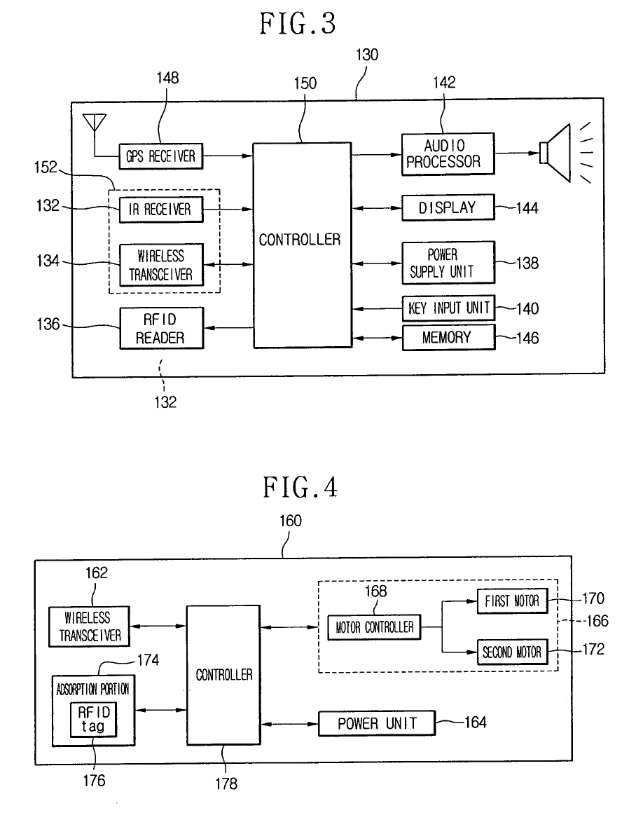

FIG. 3 is a block diagram illustrating the construction of a terminal according to an embodiment of the present invention.

Referring to FIG. 3, the terminal 130 includes an infrared (IR) receiver 132 for receiving a signal, for example, an infrared signal transmitted from the remote controller 100, a wireless transceiver 134 for transmitting a user command, which is angle adjustment information received from the IR receiver 132, to the adjustment unit 160, a power source unit 138 for supplying power, a key input unit 140 for inputting a user control command including the angle adjustment information, a memory 146 for storing danger degree information according to adsorption force, an alarming message of voice and/or audio and/or text types, and map data and data needed for the terminal 130, an audio processor 142 and a display 144 for outputting the alarming message in the form of voice and/or audio and/or text, a global positioning system (GPS) receiver 148 for detecting the position of a vehicle or other entity, an RFID reader 136 for reading an RFID signal, and a controller 150. All components of the terminal 130 are operatively coupled and/or configured.

The controller 150 control respective units of the terminal 130. When an angle adjustment command is input, the controller 150 particularly analyzes the corresponding input signal, transmits the analyzed signal to the adjustment unit 160, transmits an alarming message to the user using adsorption information input from the adjustment unit 160, and controls the terminal 130 through a data memory mode and/or a terminal protection mode.

In one example, the IR receiver 132 and the wireless transceiver 134 can be formed as one transceiver 152.

Though at least one of an infrared signal, Bluetooth communication, and an RFID signal is used in the above description, they are used according to one embodiment, and transmission/reception can be realized using another information transmission medium or means.

When an angle adjustment command is input through the IR receiver 132 (e.g., from the remote controller 100 operated by a user), the corresponding signal is analyzed. For estimation of an angle adjustment direction and/or the number of motor rotations (e.g., the number of times that the motor is to be rotated or the time length of motor rotations), information of an infrared signal is analyzed. The infrared signal is preferably transmitted in the form of the transmission format of FIG. 2 according to, e.g., the direction key input, the number of times that the direction key is input (or pressed) and/or a pressing time (e.g., time duration) of the direction key of the remote controller 100. When the input information is analyzed (e.g., by the controller 150), it is transmitted to the adjustment unit 160 using the transceiver 134 through a wired line or wirelessly.

In a preferred embodiment of the present invention, the analyzed angle adjustment information is transmitted to the adjustment unit 160 using Bluetooth, but can be transmitted through other ways.

FIG. 4 is a block diagram illustrating the construction of an adjustment unit according to an embodiment of the present invention.

Referring to FIG. 4, the adjustment unit 160 includes a transceiver 162 for receiving angle adjustment information transmitted from the terminal 130, a power source unit 164 for receiving power from the outside or from the power source unit 138 of the terminal 130, a motor controlling/operating unit 166 for driving a motor according to the angle adjustment information, an adsorption portion 174 for fixing the adjustment unit 160 on the window of a vehicle or to other surface as desired, an RFID tag 176 mounted on the adsorption portion 174 to measure adsorption pressure (adsorption force), and a controller 178 for controlling one or more motors (e.g., 170, 172) and the components of the adjustment unit 160 to operate using the motor controlling/operating unit 166 according to the angle adjustment information input through the transceiver 162. All components of the adjustment unit 160 are operatively coupled and/or configured.

The motor controlling/operating unit 166 includes a motor controller 168 for receiving control command information of the controller 178, and a first motor 170 and a second motor 172, which are one or more motors for adjusting the angle of the terminal 130.

The RFID tag 176 detects and stores the adsorption force of the adsorption portion 174 in real-time.

The RFID reader 136 of the terminal 130 receives or reads adsorption information detected from the RFID tag 176, and an alarming message can be output on the basis of a stability reference according to the adsorption information as illustrated in Table 1 below.

For example, as illustrated in Table 1, when an adsorption pressure of the adsorption portion 174 is judged to be lower than a predetermined pressure, an alarming sound is output through the audio processor 142 and/or a corresponding message is displayed on the display 144.

The adsorption portion 174 for fixing the adjustment unit 160 can be adsorbed on the window of the vehicle or the vehicle or other surface.

Also, though an angle adjustment of the terminal 130 according to the angle adjustment information of the terminal, and the control of the operating state and operation of the terminal according to the adsorption information of the adsorption portion are performed by an organic operation between the terminal and the adjustment unit according to the above embodiments, a unit for angle adjustment and/or an adsorption unit can be provided to the terminal, so that they can operate in one unit.

Table 1 below illustrates an example of one operation mode representing the operating state and operation of the terminal according to adsorption force.

TABLE 1

| Adsorption force | Operation mode | Remark |
|---|---|---|
| 15 Kgf | Reference pressure | |
| 15 Kgf | Terminal data memory | |
| | priority mode | |
| 15.5 Kgf | Terminal protection | |
| | mode (some operation | |
| | suspended) | |
| 16 Kgf | Adsorption force | |
| | check alarm mode | |

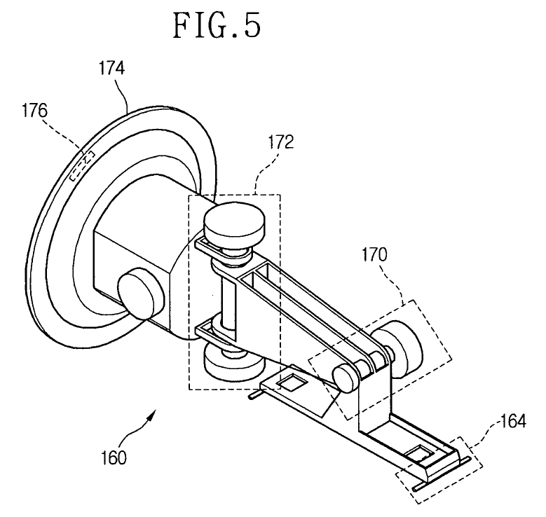

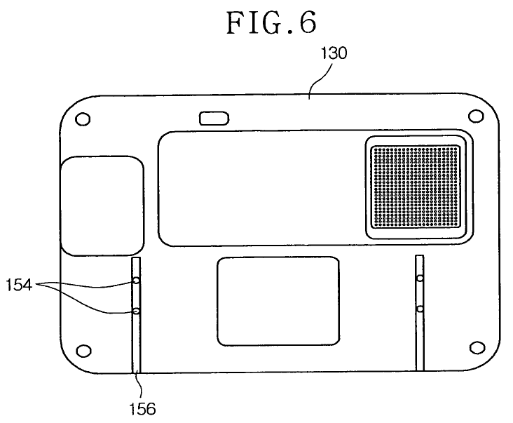

FIG. 5 is a detailed view illustrating an example of the construction of an adjustment unit (e.g., 160) according to an embodiment of the present invention, and FIG. 6 is a view illustrating an example of the construction of a power supply terminal of a power source unit 138 of a terminal (e.g., 130) according to an embodiment of the present invention.

Referring to FIGS. 5 and 6, the power source unit 164 of the adjustment unit 160 contacts a power supply terminal of the power source unit 138 of the terminal 130 through an insertion portion 156 of the terminal 130, so that power is supplied from the terminal 130 to the adjustment unit 160.

The power source unit 138 of the terminal 130 includes a ground that can output power input from the outside to allow power to be supplied to the power source unit 164 of the adjustment unit 160.

The adjustment unit 160 includes one or more motors (e.g., 170, 172) for receiving power and operating in up/down/left/right directions according to the received angle adjustment information. In an embodiment, the first motor 170 and the second motor 172 are used. Also, the adsorption portion 174 is mostly formed of rubber, and fixes the adjustment unit 160 using pressure, thereby allowing a close attachment on the window (or other surface) of the vehicle or other device so that the adjustment unit 160 does not shake.

The attaching pressure should maintain at a predetermined pressure or more to allow the adjustment unit 160 to remain on the vehicle (or surface area) without being detached. Therefore, the RFID tag 176 is preferably attached on the inner side of the adsorption portion 174 to detect adsorption force.

The adsorption force is a kind of force fixing the terminal and/or the cradle (the adjustment unit).

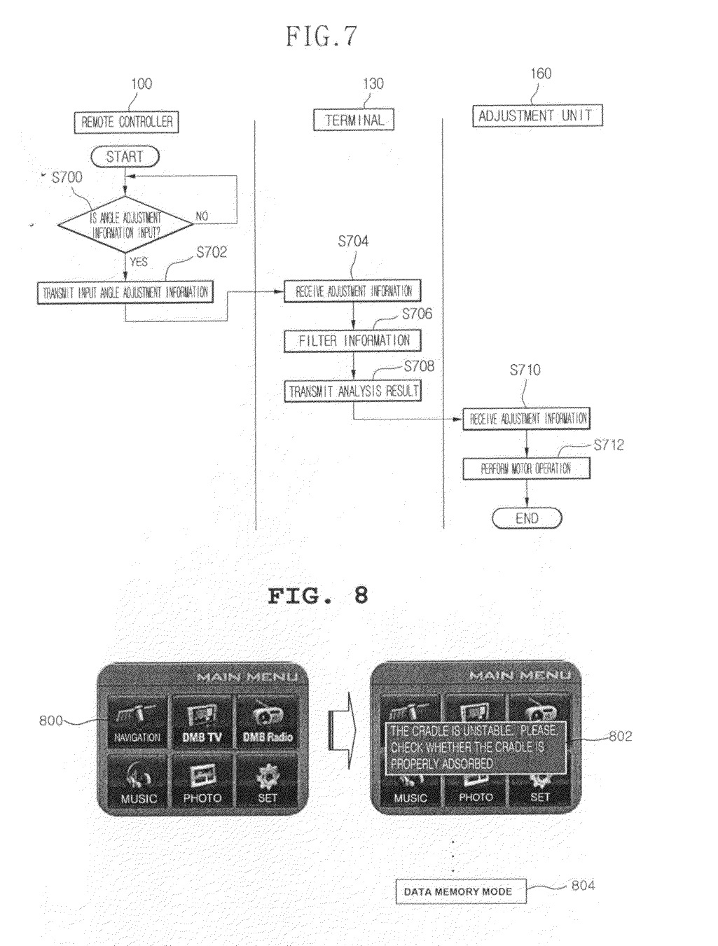

FIG. 7 is a flowchart illustrating an operating process between the respective units of the system of FIG. 1 for adjusting the angle of the terminal according to an embodiment of the present invention. This process can be equally applicable to other suitable systems.

Referring to FIG. 7, when a direction key operation of the remote controller 100 starts and angle adjustment information is input (e.g., by a user) to adjust the terminal 130 to an angle desired by a user (S700), the angle adjustment information is transmitted to the terminal 130 through an infrared signal, which is an example of an information transmission means (S702).

Generally, the terminal 130 receives the angle adjustment information of the terminal from the remote controller 100 (S704). However, the user can directly input the angle adjustment information to the terminal 130 or if desired, the system (e.g., the terminal 130) itself may determine that the angle adjustment of the terminal 130 may be needed.

According to an embodiment, the input angle adjustment information is filtered if necessary. An angle adjustment direction and an angle are analyzed using the angle adjustment information. The angle adjustment information may include, for example, at least one of the following: the direction key input (desired direction), the number of times that the direction key is input, and/or pressing time information of the remote controller 100 (S706). The analyzed angle adjustment information is transmitted to the adjustment unit 160 (S708).

The adjustment unit 160 receives the angle adjustment information transmitted from the terminal 130 (S710).

The motor operation is controlled according to the received angle adjustment information, so that the angle of the terminal 130 is controlled accordingly (S712).

Thus the present invention provides an effective way to automatically and remotely control the angle/position of the terminal 130.

FIG. 8 is a view illustrating an example of the operating mode of a terminal 800 according to adsorption information using Table 1 according to an embodiment of the present invention. Here, the terminal 800 can have the same or similar features as the terminal 130.

Referring to FIG. 8, adsorption information is detected as discussed above (e.g., through the RFID tag 176) and the detected adsorption information is analyzed. When the adsorption information is less than a predetermined pressure (e.g., 16 Kgf according to Table 1), a message saying, e.g., “The cradle is unstable. Please, check whether the cradle is properly adsorbed” (802) is displayed and/or the message is output in voice. Obviously this is one example of an alert message and other examples are possible.

Also, when the adsorption force received from the adjustment unit is less than a predetermined pressure (e.g., 15 Kgf according to Table 1), the terminal 800 is controlled to operate in a data memory mode 804 for storing data of the terminal 800.

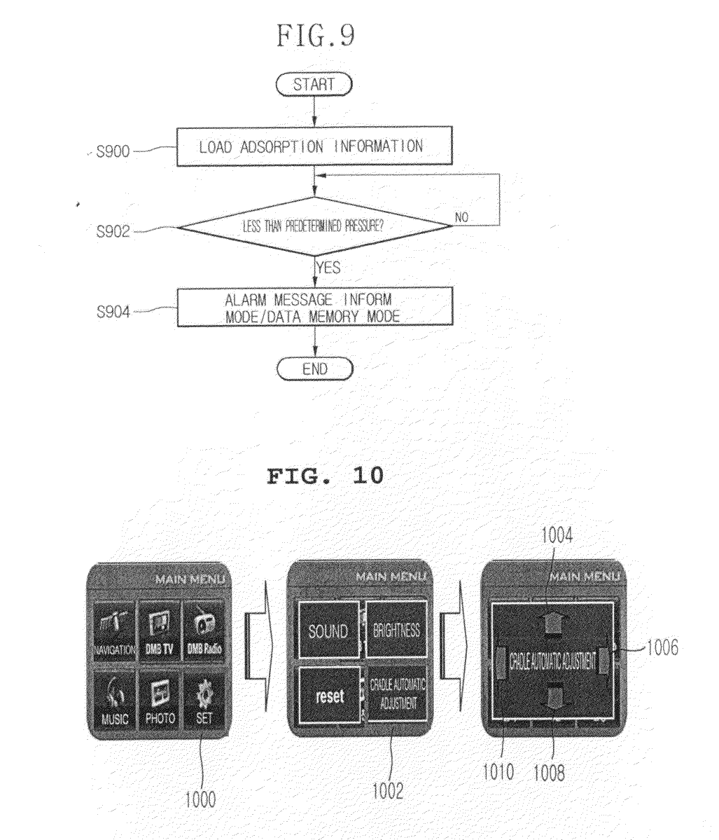

FIG. 9 is a flowchart illustrating an alarm inform mode/data memory mode according to adsorption information according to an embodiment of FIG. 8 of the present invention.

Adsorption information detected from the RFID tag 176 provided to the adjustment unit 160 is read through the RFID reader 136 of the terminal 130, and compared with data on Table 1 stored in the memory 146, so that whether the adsorption information is less than the predetermined pressure is judged, e.g., by the controller 150 (S900-S902).

When the adsorption force is judged to be less than the predetermined pressure as a result of the judgment in operation S902, an alarm message is displayed and/or audibly communicated to a user (e.g., through the display 144 and/or audio processor 142), or the terminal is controlled to operate in a data memory mode or some other mode (S904).

FIG. 10 is a view illustrating an example of directly inputting angle adjustment information to a terminal according to another embodiment of the present invention.

Referring to FIG. 10, the angle adjustment information is input using a touch screen of the display 144 of the terminal 130.

When a tap of “set” 1000 that can adjust the cradle, which is the adjustment unit, is selected from the menu of the terminal, a tap of “cradle automatic adjustment” 1002 is formed. When the tap 1002 is selected by the user, then an adjustment window is shown.

When the adjustment window is displayed, angle adjustment information formed by, e.g., key inputting, the number of times of inputting keys, and/or the pressing times of up/down/left/right direction keys (1004, 1006, 1008, 1010) on a quadrangular shape is transmitted to the adjustment unit 160 to operate one or more motors, so that the cradle is adjusted appropriately, which in turn adjusts the angle or position of the terminal mounted on the cradle.

According to an embodiment, the motor is operated according to the angle adjustment information calculated using at least one of the key(s) inputted, the number of times that the inputting operations are performed, and the pressing time of direction keys to perform an angle adjustment operation. The angle adjustment information calculated using the key inputting, the number of times that the inputting operations are made, and the pressing time of direction keys can be determined beforehand and stored in the memory 146.

When the angle adjustment information is received through the remote controller or the angle adjustment information is input directly through an automatic adjustment menu separately provided to the terminal, the received or input angle adjustment information is analyzed to control the motor(s) of the adjustment unit, so that a user is prevented from directly adjusting the angle of the terminal with his hand while driving or from turning his head because of the tilted angle of the terminal, which results in safe driving.

The method of FIG. 9 can be applied as part of the methods of FIGS. 7, 8 and 10. For example, at step S710, the adjustment unit 160 may check the adsorption information as in the process of FIG. 9 and decide whether to proceed with the motor operation of S712.

Although embodiments have been described with reference to a number of illustrative embodiments thereof, it should be understood that numerous other modifications and embodiments can be devised by those skilled in the art that will fall within the spirit and scope of the principles of this disclosure.

For example, the angle adjustment information can be input to the angle adjustment unit through the remote controller and the terminal, input through the terminal, or directly input to the angle adjustment unit without passing through the terminal.

The construction of the angle adjustment unit can be modified (added, deleted, or function-complemented) according to various angle adjustment information input routes to the angle adjustment unit.

As described above, the inputting of the angle adjustment information to the adjustment unit for adjusting the angle of the terminal can be performed through various paths. The above description is mere examples. It would be obvious to those skilled in the art to realize other input methods using the embodiments.

Also, an infrared (IR) ray, RFID, or Bluetooth described as a transmission means for receiving/transmitting information is mere one embodiment for realizing the present disclosure, and other transmission means can be used.

Also, though description has been made using a navigation unit as an example in the present disclosure, the present invention can be applied to other user terminals, for example, a PMP, etc.

According to the present invention, when angle adjustment information is input through the remote controller or through the automatic adjustment menu separately provided to the terminal, the received angle adjustment information is analyzed to automatically control the motor of the adjustment unit.

Also, according to the present invention, adsorption force information is detected whenever necessary and informed of to the user, so that destruction of the cradle and the terminal due to impact of falling, and materials can be protected safely.

The scope of the invention is defined by the appended claims, and all differences within the scope will be construed as being included in the present invention.

What is claimed is:

1. A method for operating a terminal, the method comprising:
receiving angle adjustment information of a terminal; and
automatically controlling a position of the terminal according to the angle adjustment information.

2. The method according to claim 1, wherein the angle adjustment information includes at least one of the following: a direction key input, the number of times that the direction key is input, and pressing time information associated with the direction key input.

3. The method according to claim 1, wherein the angle adjustment information is received by an adjustment unit directly from the terminal, or indirectly from the terminal through a remote controller.

4. A method for operating a terminal, the method comprising:
measuring adsorption force of a fixing unit for fixing at least one of a terminal or an adjustment unit;
comparing the adsorption force with a predetermined reference value; and
controlling an operating mode of at least one of the terminal or the adjustment unit according to the comparison result.

5. The method according to claim 4, further comprising:
outputting an alarm regarding the adsorption force on the basis of the result of comparing the adsorption force with the reference value.

6. The method according to claim 4, further comprising:
outputting an apparatus protection message for at least one of the terminal or the adjustment unit on the basis of the result of comparing the adsorption force with the reference value.

7. The method according to claim 4, further comprising:
storing data stored in at least one of the terminal or the adjustment unit on the basis of the result of comparing the adsorption force with the reference value.

8. An apparatus for operating a terminal whose angle is adjustable, the apparatus comprising:
an input unit configured to perform at least one of receiving or inputting angle adjustment information; and
an adjustment unit configured to automatically adjust the angle of the terminal using the angle adjustment information.

9. The apparatus according to claim 8, further comprising:
a fixing unit configured to fix the terminal.

10. The apparatus according to claim 8, wherein the adjustment unit comprises one or more motors.

11. A method for operating a terminal, the method comprising:
when a remote controller receives angle adjustment information, transmitting the angle adjustment information to the terminal;
analyzing, at the terminal, the angle adjustment information received through the remote controller, and transmitting the angle adjustment information to an adjustment unit; and
controlling, at the adjustment unit, a motor according to the angle adjustment information to perform an angle adjustment operation of the terminal.

12. An apparatus for operating a terminal, the apparatus comprising:
an infrared receiver configured to receive angle adjustment information;
a transceiver configured to output the angle adjustment information received through the infrared receiver;
a radio frequency identification reader configured to read adsorption information of an adjustment unit; and
a controller configured to analyze the angle adjustment information received through the infrared receiver and to transmit a corresponding signal to the adjustment unit through the transceiver, the controller configured to read the adsorption information of the adjustment unit, and to inform a user of the adsorption information.

13. The apparatus according to claim 12, further comprising:
an audio processor configured to output an alarm message in the form of voice and/or sound when the adsorption information read by the radio frequency identification reader is less than a predetermined pressure;
an output unit configured to output the alarm message; and
a power supply unit configured to supplying power to the terminal and to supply power through the terminal provided to the adjustment unit.

14. The apparatus according to claim 12, wherein the infrared receiver obtains the angle adjustment information transmitted from a remote controller in the form of an infrared signal, and outputs the angle adjustment information to the controller.

15. The apparatus according to claim 12, wherein the transceiver transmits the angle adjustment information to the adjustment unit using Bluetooth, wirelessly.

16. The apparatus according to claim 12, wherein the radio frequency identification reader reads and outputs the adsorption information detected from a radio frequency identification tag provided to the adjustment unit.

17. An apparatus for operating a terminal, the apparatus comprising:
a second power source unit grounded with a first power source unit of the terminal to receive power;
a second transceiver configured to receive angle adjustment information transmitted from a first transceiver of the terminal;
a motor controlling/operating unit configured to perform an adjustment operation according to the angle adjustment information received from the second transceiver; and
a controller configured to control the adjustment operation to be performed by the motor controlling/operating unit when the angle adjustment information is input.

18. The apparatus according to claim 17, further comprising:
an adsorption portion configured to perform a fixing operation on a vehicle using adsorption force; and
a radio frequency identification tag provided to the adsorption portion and configured to detect a pressure degree.

19. The apparatus according to claim 17, wherein the motor controlling/operating unit comprises:
one or more motors; and
a motor controller configured to control operations of the one or more motors according to the angle adjustment information.

20. The method according to claim 1, further comprising:
detecting an adsorption force between the terminal and an adjustment unit used to control the position of the terminal; and
selectively generating an alert signal pertaining to the position of the terminal based on the detection result.
